(19) United States
(12) Patent Application Publication
(10) Pub. No.: US 2010/0187318 A1
(43) Pub. Date: Jul. 29, 2010

(54) VAV SOLID STATE VAV FAN SERIES AND PARALLEL FAN CONTROLLER

(76) Inventor: KENNETH S.P. YU, San Gabriel, CA (US)

Correspondence Address: COHEN I.P. LAW GROUP, P.C., 9025 Wilshire Blvd., Suite 301, Beverly Hills, CA, 90211, US

(21) Appl. No.: 12/361,270

(22) Filed: Jan. 28, 2009

(51) Int. Cl. F24F 7/00; G05D 23/19; G05B 15/00

(52) U.S. Cl. 236/49.3; 236/78 R; 700/275

(57) ABSTRACT

A VAV solid state VAV fan series and parallel fan controller for controlling a fan and at least one stage of reheat in a ventilation system in response to signals from an external VAV controller is disclosed. The VAV solid state VAV fan series and parallel fan controller is in connection with at least one transformer, external VAV controller, fan, speed adjuster, reheat device, and circuit breaker for conditioning an air volume. A sensor associated with the external VAV controller constantly monitors room temperature and generates signals for the controlled operation of the device. The preferred invention has a plurality of terminal blocks with each terminal block having single point connections. The invention includes at least one fan relay that initiates power to start the fan and at least one reheat relay that initiates power to reheat device in stages in response to the signals from the external VAV controller.

### CROSS-REFERENCE TO RELATED APPLICATIONS

Not Applicable.

### STATEMENT REGARDING FEDERALLY SPONSORED RESEARCH AND DEVELOPMENT

Not Applicable.

### FIELD OF THE INVENTION

This invention relates to air conditioning system, and more particularly to A VAV solid state VAV fan series and parallel fan controller for controlling a fan and at least one stage of reheat in a ventilation system.

### DISCUSSION OF RELATED ART

Various devices and methods have been adopted for conditioning the space within buildings and plants. VAV (variable air volume) system is a type of all-air system used to condition air. Such devices have an automatic control for regulating the air and it has the advantage of reducing the energy consumption. Constraints like the temperature of the surrounding, the shape of the defined space, the velocity of the air stream and, the diffuser design that distributes the air into the space are considered for conditioning the space.

Typically, prior art apparatus for supplying conditioned air to a plurality of zones has a microcomputer-based system coordinator. The VAV system coordinator coordinates a central system VAV cooling and heating operation based on the zone requirements of its associated slave thermostats and fan box monitors. Such an air conditioner is bulky and it demands a large space for storage.

Usually, large HVAC (heating, ventilation, and air conditioning) units supply conditioned air to various zones that may or may not have individual zone dampers. As various zone dampers are closed because the zone demands have been met, as established by a local thermostat, the airflow through the remaining dampers will increase. This may cause an unexpected surge in outflow from any of the dampers. A central HVAC unit is required; as the fan powered mixing box assemblies have no independent source of cooling or heating. Moreover, the central HVAC unit proves to be economical.

Another prior art says a method to obtain occupant comfort in a defined closed space, cooling air from a variable air volume terminal should be uniformly mixed with the air in the space. When cooling demand is high in the space, the cooling air velocity from the diffuser must necessarily be high. As the pressure of the high velocity air is low, it clings to the ceiling of the space. When the cooling load is low, the low velocity air does not cling to the sealing and the cold air drops in a column between the diffuser and the floor of the space. Such a phenomenon produces a very spotty undesirable temperature and air flow envelope within the space.

Prior art discloses an air conditioner whereby a fan, driven by an electric motor, is used to provide an air flow over the coils of the evaporator to enhance the transfer of heat energy from the air to the refrigerant in the evaporator. A compressor associated with the air conditioner is also driven by an electric motor. Such a device has the disadvantage that the two motors associated with the air conditioner consume more energy than the fan motor.

Therefore, there is a need for a device that is compact and consumes less space for storage. Such a device would solve the problem of wiring the components together with loose wires. In addition, single point connection in the device would expect less labor time and better wiring understanding. Further, such a device would be economical and would have a provision for constant sensing of temperature and conditioning of air volume. The present invention accomplishes these objectives.

### SUMMARY OF THE INVENTION

The present invention is a VAV solid state VAV fan series and parallel fan controller for controlling a fan and at least one stage of reheat in a ventilation system, in response to signals from an external VAV controller. The VAV fan series and parallel fan controller has a plurality of terminal blocks with each terminal block having single point connection. The invention includes at least one fan relay that initiates power to start the fan and at least one reheat relay that initiates power to reheat device in stages in response to the signals from the external VAV controller. A sensor associated with the external VAV controller constantly monitors room temperature and generates signals for the control operation of the reheat device.

The VAV solid state VAV fan series and parallel fan controller is connected to at least one transformer, external VAV controller, fan, speed adjuster, reheat device, and circuit breaker for conditioning an air volume. The first terminal block has connection points for common power supply, neutral power supply, earth ground ground, unit ground, and circuit breaker. A second terminal block has connection points for common fan, low fan, medium fan and high fan. The fan is in connection with each connection point of the second terminal. A third terminal block has a plurality of relay connection points each for low fan, medium fan and high fan. Each connection point in the third terminal block is in connection with the corresponding low fan, medium fan and high fan connection points in the second terminal block.

A fourth terminal block has connection points for fan relay common, reheat common, at least one normally closed reheat common and at least one normally open reheat common. At least one normally closed reheat common and at least one normally open reheat common connection points connect at least one of the plurality of reheat relays with the reheat device. Both the fifth terminal block and the sixth terminal block have a power supply and a common supply connection points for the transformer. A seventh terminal block has a power supply and power common connection points for the external VAV controller. A reheat fan start connection point and at least one reheat stage connection point in the seventh terminal block receives signals from the external VAV controller. The output signals from the external transformer is received by the sixth terminal block thereby provides power supply and common supply for the external VAV controller.

The present invention facilitates compact design and consumes less space for storage. Such a device solves the problem of wiring the components together with loose wires. Single point connection in the device expects less labor time and better wiring understanding. The present invention is economical and has provision for constant sensing of temperature and conditioning of air volume. Other features and advantages of the present invention will become apparent from the following more detailed description, taken in conjunction with the accompanying drawings, which illustrate, by way of example, the principles of the invention.

### DESCRIPTION OF THE DRAWINGS

FIG. 1 is a perspective top view of the invention, illustrating a VAV solid state VAV fan series and parallel fan controller connected with at least one transformer, an external controller, a fan, a speed adjuster, a reheat device, and a circuit breaker for conditioning a ventilation system;

FIG. 2 is a block diagram of the invention, illustrating a method of controlling a fan and at least one stage of reheat in a ventilation system with the VAV solid state VAV fan series and parallel fan controller;

FIG. 3 is an electronic circuitry for implementing the present invention; and

FIG. 4 is a flow diagram, illustrating a method of operation of the present invention.

### DETAILED DESCRIPTION OF THE PREFERRED EMBODIMENT

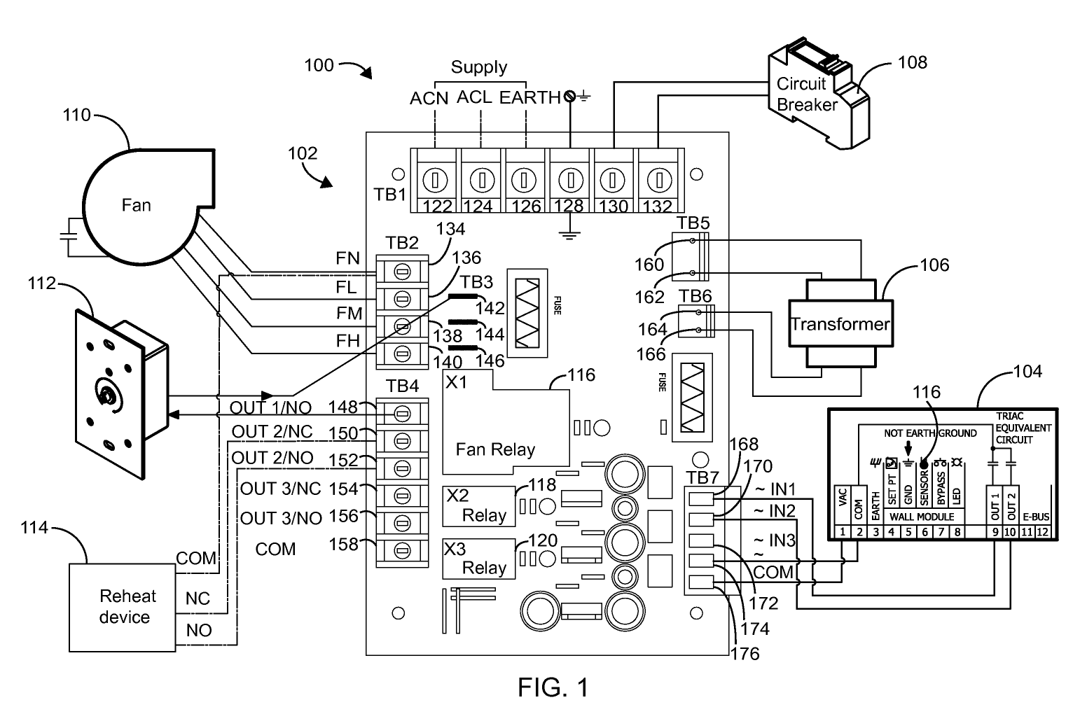

FIG. 1 shows a perspective view of a VAV solid state VAV fan series and parallel fan controller 102 for controlling a fan 110 and at least one stage of reheat (X2, X3) in a ventilation system(not shown), in response to signals from an external VAV controller 104. The VAV fan series and parallel fan controller 102 has a plurality of terminal blocks (TB1, TB2, TB3, TB4, TB5, TB6 and TB7). Each terminal block (TB1, TB2, TB3, TB4, TB5, TB6 and TB7) has single point connections. At least one VAV solid state fan relay 116 initiates power to start the fan 110 in response to the signals from the external VAV controller 104. At least one VAV solid state reheat relay (X2 and X3) initiates power to reheat device 114 in stages in response to the signals from the external VAV controller 104. A sensor 116 associated with the external VAV controller 104 constantly monitors room temperature and generates signals for the control operation of the reheat device 114.

The VAV fan series and parallel fan controller 102 is connected to at least one transformer 106, external VAV controller 104, fan 110, speed adjuster 112, reheat device 114, and circuit breaker 108 for conditioning an air volume. A first terminal block (TB1) receives input power supply. The first terminal block (TB1) has connection points for common power supply 124, neutral power supply 122, earth ground ground 126, unit ground 128, and circuit breaker 108. The circuit breaker 108 which is in connection with the connection points 130 and 132 in the first terminal block (TB1). A second terminal block (TB2) has connection points for common fan 134, low fan 136, medium fan 138 and high fan 140. Each connection point of the second terminal (TB2) is in connection with the fan 110. A third terminal block (TB3) has a plurality of relay connection points each for low fan 142, medium fan 144 and high fan 146. Each connection point in the third terminal block (TB3) is in connection with the corresponding low fan 136, medium fan 138 and high fan 140 connection points of the second terminal block (TB2).

A fourth terminal block (TB4) has connection points for fan relay common 148, reheat common 158, at least one normally closed reheat common (150 and 154) and at least one normally open reheat common (152 and 156). At least one normally closed reheat common (150 and 154) and at least one normally open reheat common (152 and 156) connection points connect at least one of the plurality of VAV solid state reheat relays (118 and 120) with the reheat device 114. The speed adjuster 112 for adjusting the fan speed connects the fan relay common connection point 148 of the fourth terminal block (TB4) with the third terminal block (TB3). Both the fifth terminal block (TB5) and the sixth terminal block (TB6) have a power supply (160 and 164) and a common supply (162 and 166) connection points respectively. The transformer 106 receives input signal from the fifth terminal block (TB5) and sends output signal to the sixth terminal block (TB6).

A seventh terminal block (TB7) has a power supply 174 and power common 176 connection points for the external VAV controller 104. A reheat fan start connection point 168 and at least one reheat stage connection point 170 in the seventh terminal block (TB7) receives signals from the external VAV controller 104. The output signals from the external transformer 106 is received by the sixth terminal block (TB6) thereby provides power supply 174 and common supply 176 for the external VAV controller 104.

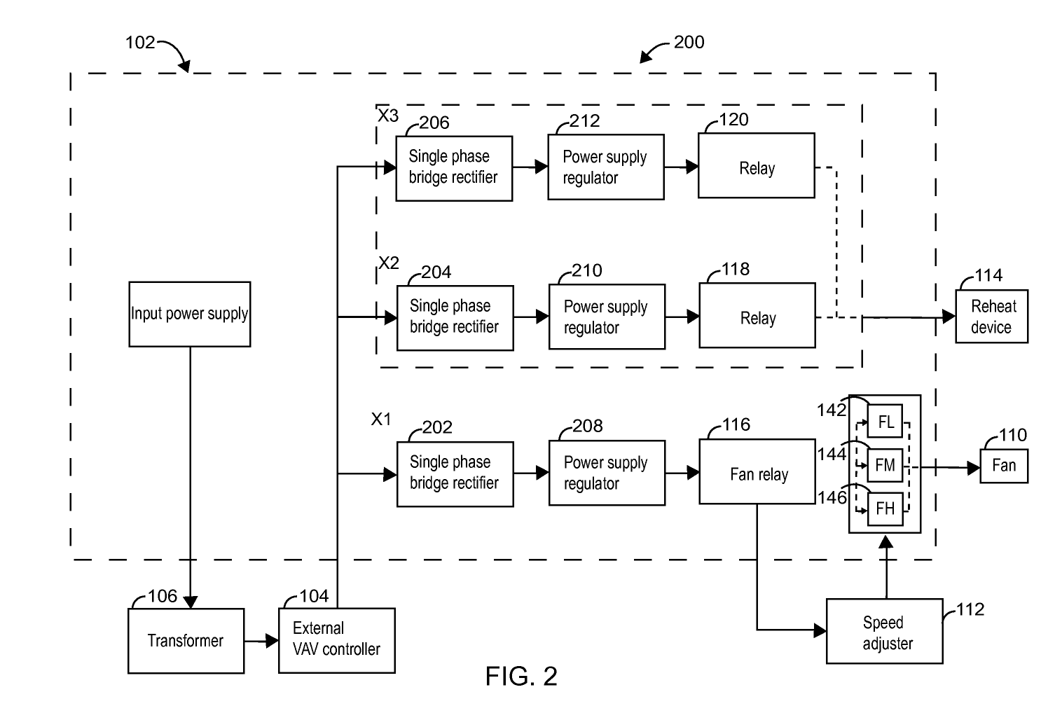

Preferably, referring to FIG. 2 represents a block diagram 200 illustrating the controlled operation of the fan 110 and at least one stage of reheat (X2 and X3) in a ventilation system (not shown) with the VAV fan series and parallel fan controller 102. The transformer 106 receives the input power supply 214 and provides power supply for the operation of the external VAV controller 104. The external VAV controller 104 sends appropriate signals to the VAV solid state VAV fan series and parallel fan controller 102. At least one single phase bridge rectifier 202 and power supply regulator 208 that are in connection with each of the fan relay circuitry (X1) and at least one reheat relay circuitry (X2 and X3) provide better control operation of the VAV solid state VAV fan series and parallel fan controller 102. The at least one reheat relay circuitry (X2 and X3) sends signals to the reheat device 114 in stages in response to the signals from the external VAV controller 104. The fan speed can be adjusted with a speed adjuster 112 at any point of time while the VAV solid state VAV fan series and parallel fan controller 102 is working. The fan 110 works in low 142, medium 144 and high 146 speed.

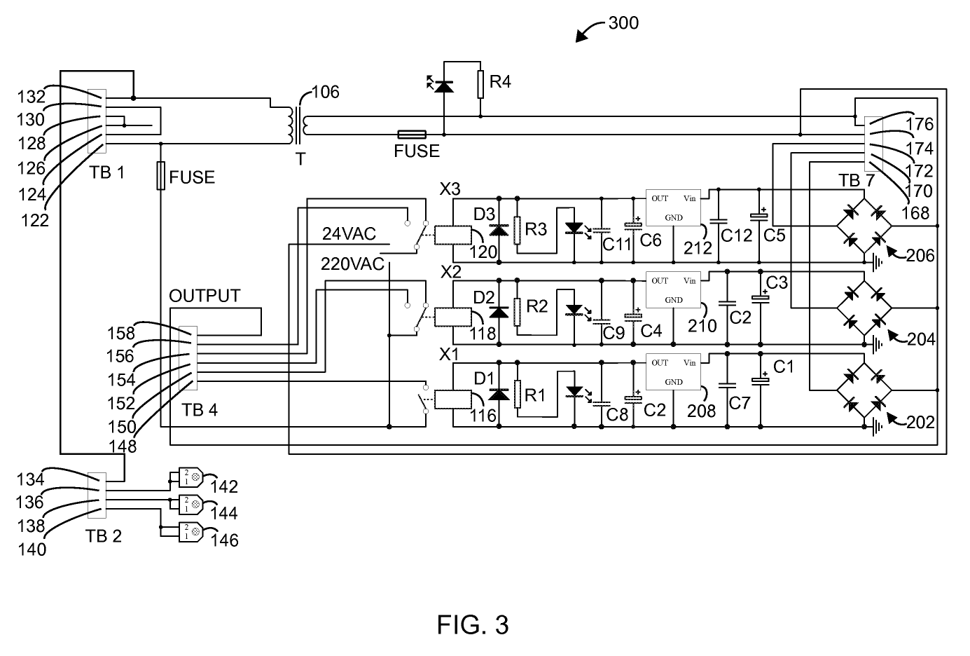

FIG. 3 is an electronic circuitry 300 for implementing the present invention. The external VAV controller 104 receives power supply 174 and common supply 176 required for the operation from the transformer 106. The external VAV controller 104 sends fan start signal through the reheat fan start connection point 168 in the seventh terminal (TB7). The signals then pass through the single phase bridge rectifier 202, the power supply regulator 208, at least one diode (D1) and resister (R1), and a plurality of capacitors (C1,C7,C2 and C8) in the fan relay circuitry (X1) to initiate fan start. The external VAV controller 104 sends signals to initiate reheat stages (X2 and X3) through the reheat stage connection points (170 and 172) in the seventh terminal (TB7). The signals then pass through single phase bridge rectifier (204 and 206), the power supply regulator (210 and 212), at least one diode (D2 and D3), and a plurality of capacitors (C3, C2, C4, C9 and C5, C12, C6, C11) and resisters (R2 and R3) in the reheat relay circuitry (X2 and X3) to reach the reheat device 114 respectively. The reheat device 114 may be a hydronic valve.

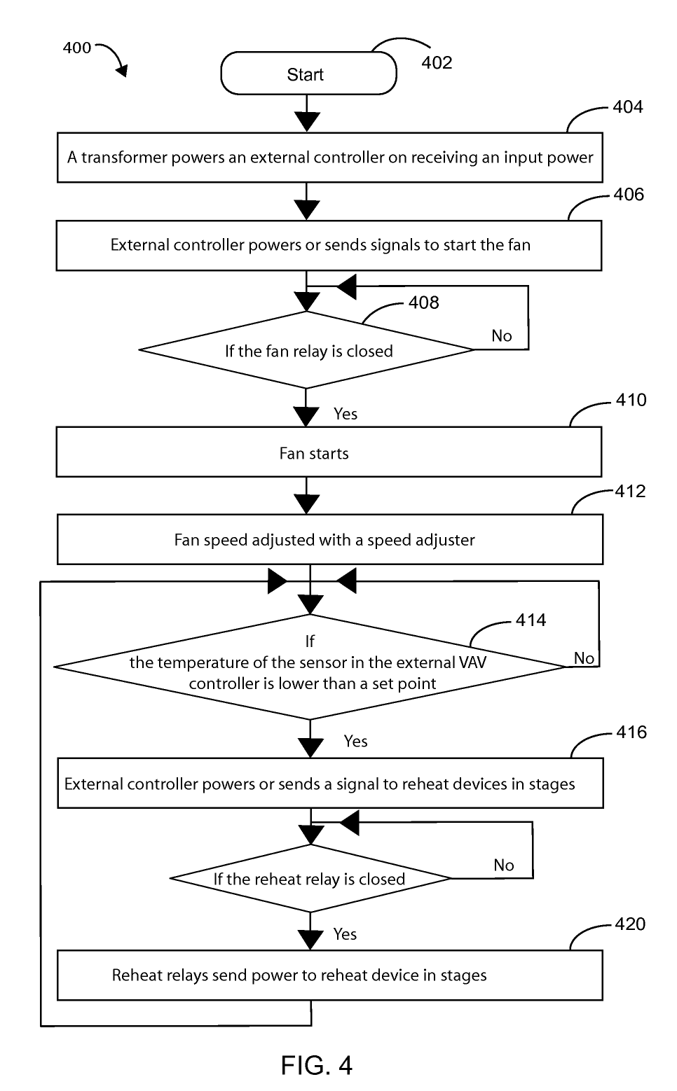

FIG. 4 is a flow diagram illustrating a method of operation of a VAV solid state VAV fan series and parallel fan controller 102 in response to signals from an external VAV controller 104. In step 404, the external VAV controller 104 receives power when the VAV solid state VAV fan series and parallel fan controller receives input power supply. In step 406, the external VAV controller 104 sends a control signal to close the fan relay 116 to initiate fan start. Step 408 checks whether the fan relay 116 is closed. In step 410, the fan 110 starts running. In step 412, the fan speed is adjusted by adjusting a speed adjuster 112. In step 414, room temperature is constantly monitored with a sensor 116 in the external VAV controller 104 for a set point. In step 416, the external VAV controller 104 sends a signal to reheat device 114 in stages when the sensed signal is lower than a set point. Step 418 checks whether at least one reheat relay (118 and 120) is closed. In step 420, the reheat relays (118,120) send power to reheat device 114 in stages.

While a particular form of the invention has been illustrated and described, it will be apparent that various modifications can be made without departing from the spirit and scope of the invention. For example, the number of stages of reheat relay and the relay fan connections can be altered. Accordingly, it is not intended that the invention be limited, except as by the appended claims.

What is claimed is:

1. A VAV solid state VAV fan series and parallel fan controller for controlling a fan and at least one stage of reheat in a ventilation system, in response to signals from an external VAV controller, the VAV fan series and parallel fan controller comprised of:
a plurality of terminal blocks each having a plurality of connection;
at least one fan relay initiating power to start the fan in response to the signals from the external VAV controller; and
at least one reheat relay initiating power to reheat device in stages in response to the signals from the external VAV controller.

2. The VAV fan series and parallel fan controller of claim 1 wherein each of the plurality of terminal blocks have single point connection.

3. A VAV solid state VAV fan series and parallel fan controller for controlling a fan and at least one stage of reheat in a ventilation system, the VAV solid state VAV fan series and parallel fan controller is in connection with a plurality of external components, the components comprised of:
at least one external VAV controller supplying signals to fan relay and reheat relay;
at least one transformer supplying power to the external VAV controller;
at least one fan that operates in various levels of speed;
at least one speed adjuster for adjusting the speed of the fan;
at least one reheat device conditioning the air volume in a ventilation system; and
at least one circuit breaker protecting the VAV solid state VAV fan series and parallel fan controller from power surge.

4. A VAV solid state VAV fan series and parallel fan controller for controlling a fan and at least one stage of reheat in a ventilation system, the VAV solid state VAV fan series and parallel fan controller having a plurality of terminal blocks, the plurality of terminal blocks are:
a first terminal block having connection points for power supply, earth ground ground, unit ground, and circuit breaker;
a second terminal block having connection points for common fan, low fan, medium fan and high fan;
a third terminal block having a plurality of relay connection points each for low fan, medium fan and high fan;
a fourth terminal block having connection points for fan relay common, reheat common, at least one normally closed reheat common and at least one normally open reheat common;
a fifth terminal block and a sixth terminal block, each terminal block having a power supply and common supply connection points; and
a seventh terminal block having a power supply, power common, a reheat fan start and at least one reheat stage connection point.

5. The VAV fan series and parallel fan controller of claim 4 wherein each connection point in the second terminal block are in connection with a fan.

6. The VAV fan series and parallel fan controller of claim 4 wherein each connection point in the third terminal block is in connection with the corresponding low fan, medium fan and high fan connection points in the second terminal block.

7. The VAV fan series and parallel fan controller of claim 4 wherein at least one normally closed reheat common and at least one normally open reheat common connection points in the fourth terminal block connects at least one of a plurality of VAV solid state reheat relays and the reheat device.

8. The VAV fan series and parallel fan controller of claim 4 wherein a transformer connects the fifth terminal block with the sixth terminal block.

9. The VAV fan series and parallel fan controller of claim 1 wherein the output signals from the external transformer is received by the sixth terminal block thereby supplying power supply and common supply for the external VAV controller.

10. The VAV fan series and parallel fan controller of claim 4 wherein an external VAV controller receives power through the power supply and power common connection points in the seventh terminal, the reheat fan start connection point and at least one reheat stage connection point receiving signals from the external VAV controller.

11. The VAV fan series and parallel fan controller of claim 4 wherein the speed adjuster for adjusting the fan speed connects the fan relay common connection point of fourth terminal block with the third terminal block.

12. The VAV fan series and parallel fan controller of claim 1 wherein at least one single phase bridge rectifier and power supply regulator in connection with each of the fan relay and at least one reheat relay provide better control operation.

13. A method of controlling a fan start and at least one stage of reheat of a VAV solid state VAV fan series and parallel fan controller in a ventilation system, in response to signals from an external VAV controller, comprising:
(a) powering the external VAV controller when the VAV solid state VAV fan series and parallel fan controller receives input power supply;
(b) sending a control signal from the external VAV controller to close the fan relay to initiate fan start;
(c) adjusting the fan speed with a speed adjuster;
(d) monitoring room temperature constantly with a sensor in the external VAV controller and
(e) comparing the monitored room temperature with a set point of the sensor in the external VAV controller;
(f) sending a control signal from the external VAV controller to close reheat relays in stages to initiate reheat start when the room temperature is less than the set point; and
(g) sending power to reheat device in stages when the reheat relays are closed.

14. The method of claim 13 wherein the reheat stages change depending on logic, time, temperature and the set point of the external VAV controller.

15. The method of claim 13 wherein the speed adjuster may be adjusted manually to regulate the fan speed, while the device is working.
